(19) United States
(12) Patent Application Publication
(10) Pub. No.: US 2004/0033836 A1
(43) Pub. Date: Feb. 19, 2004

(54) Otf system

(76) Inventors: Nancy Lyn Sebastian, Fairhope, AL (US); Jennifer Taylor Hayes, Fairhope, AL (US)

Correspondence Address: Nancy Sebastian, 223 Lake Ridge Drive, Fairhope, AL, 36532, US

(21) Appl. No.: 10/298,285

(22) Filed: Nov. 18, 2002

Related U.S. Application Data
(60) Provisional application No. 60/403,347, filed on Aug. 14, 2002.

(51) Int. Cl. A63F 9/24; A63F 13/00; G06F 17/00; G06F 19/00

(52) U.S. Cl. 463/46

(57) ABSTRACT

A process to re-furbish gaming machines. This method has proven to be cost efficient for the gaming industry. The removal of old laminate and the application of new is an order-less, non-intrusive manner preformed on the slot floor of the casino. The completion of the method in a matter of hours saves time on the shut down of gaming machines.

A method designed to assist in the re-lamination of gaming machines directly on the slot floor of casinos. Prior to this invention, the gaming industry had to remove the gaming machines to off-site laminating companies. This method allows us to do up to twenty-four machines in four hours. The process is done without the removal of the handle mechanism.

The advantages of this method are:

In order for the machines to be removed from the casinos to off-site laminating companies, the gaming industry has to first get permission from the State Gaming Commission because of the strict laws governing the industry. This could take weeks to achieve. This method has eliminated this process and thereby saves time.

By doing this directly on the floor twenty-four machines can be laminated in four hours. This saves money since the machines are only inoperable for approximately four hours.

There is time involved in preparing the gaming machines for this process. The gaming technicians have to remove some of the parts of the machine, but do not have to remove the handle mechanism. The removal of the handle mechanism is both tedious and time consuming. This saves the gaming technicians approximately thirty minutes per machine in preparation time.

This method is odor-less. The gaming machines do not have to come offline as to require a coin test. The gaming technicians have to unbolt the machines from the base, remove the candle, the ID tag, the re-set lock, and the handle, but not the handle mechanism.

New laminate is cut from a template. The old laminate is removed with a heat gun and a scraper. A Hole Saw is used to cut around the handle mechanism to remove the laminate without unbolting the handle mechanism from the machine.

The new laminate is applied with an odorless contact adhesive. New T-Molding is hammered into place with a rubber mallet.

What is claimed is:

1. Re-laminating the gaming machines directly on the slot floor of the casino saves both time and money for the gaming industry.
